(19) United States
(12) Patent Application Publication
(10) Pub. No.: US 2013/0173265 A1
(43) Pub. Date: Jul. 4, 2013

(54) Speech-to-online-text system

(71) Applicants: Chiaka Chukwuma Okoroh, Chicago, IL (US); Nathaniel A. Moore, Chicago, IL (US)

(72) Inventors: Chiaka Chukwuma Okoroh, Chicago, IL (US); Nathaniel A. Moore, Chicago, IL (US)

(21) Appl. No.: 13/374,543

(22) Filed: Jan. 3, 2012

(51) Int. Cl. G10L 15/26

(52) U.S. Cl. 704/235; 704/E15.043

(57) ABSTRACT

Speech-to-text software, sometimes known as dictation software, is software that lets you talk to the computer in some form and have the computer react appropriately to what you are saying. This is totally different to text-to-speech software, which is software can read out text already in the computer. Speech-to-online-text software allows you to speak words into the webpage of an Internet capable device. Speech-to-online-text software will also support the capabilities provided by speech-to-text software. The hardware required to support this technology is an Internet capable device and a compatible microphone. This capability will be especially useful for communicating in different languages and dialects around the world.

### CROSS REFERENCE TO RELATED APPLICATIONS

This patent is related to a Nonprovisional Patent Application (application Ser. No. 13/199,061).

### BACKGROUND OF THE INVENTION

Synchronous distance learning occurs when the teacher and his/her pupils interact in different places at the same time. Students enrolled in synchronous courses are generally required to log on to their computer during a set time at least once a week. Synchronous distance learning may include multimedia components such as group chats, web seminars, video conferencing, and phone call-ins. Generally, synchronous learning works best for students who can schedule set clays and times for their studies. It is often preferred by those who like structured courses heavy on student interaction. As we all know, the online environment is text-based. Communication with an instructor and other students in an online classroom requires the participants to type messages and post responses. For many students, typing is slower than writing. However, for all students, typing is slower than speaking. The point is that you will likely learn more in an online classroom environment, but you will have to make a greater effort to accomplish that learning.

Online tutoring services cover a wide spectrum of capabilities. Some are legitimate, with tutors who are interested in helping a student learn the material on their own. Other sites provide answers to homework problems with no explanations given. It is sites like these that have teachers worried about the value of the help they offer. There are quick-fix sites with little quality control or real concern about a student's education. Independent research shows a tremendous increase in supplemental academic learning services. With standards falling in many schools and competition fierce for college entry, more parents and students are turning to private tutors for assistance. There is a growing need for parents to access the best private tutors for a particular subject, no matter the location.

The online tutoring space, for example, can potentially use this technology to communicate symbolic representations specific to various educational subjects (such as math, chemistry, physics, etc.). The word ‘pi’ can be communicated via a microphone and appear as π on a website for those who tutor in mathematics. In chemistry, the symbols of a chemical element are abbreviations that are used to denote a chemical element. A chemistry tutor using this technology can communicate elements from a periodic table into a microphone and the corresponding symbol could appear on the tutoring site.

### SUMMARY OF THE INVENTION

Online tutoring services that use digital ‘whiteboards’ to show work and explain how to solve problems are likely to be a much better long-term solution than email help services. There exists a potential opportunity for online educators and tutors to take advantage of the speech-to-online-text technology. Speech-to-online-text technology will allow people to capture and store everything that one handwrites on a PC or MAC. This solution will provide a culture of environmental responsibility since less natural resources are consumed. This capability would eliminate the need for private tutors to travel to their clients to do face to face discussions. This potentially means less vehicles on the road acting on behalf of educational service, which in turn supports the green initiative. Tutoring sessions will have audio and video capabilities as well as an online whiteboard that appears as a result of internal/external speech-to-online-text software. The online handwriting capability can be accessible to both the tutor and the person being tutored. Students will have the ability to rate the tutors. More importantly, private tutors around the world could be made available to give a child the best opportunity to succeed in their studies. Speech-to-online-text technology could also prove beneficial to other industries as well. Physicians, for example, could communicate their prescriptions on a webpage and have it readily available for a pharmacist to read. Internet savvy people who lack typing skills can now communicate their text onto a webpage and reach out to a long lost friend thousands of miles away. In the audio/visual industry, there has been a huge uptake of computer-based audio-visual equipment in the education sector, with many schools and higher educational establishments installing projection equipment. The application of audiovisual systems is found in collaborative conferencing (which includes video-conferencing, audio-conferencing, web-conferencing and data-conferencing); presentation rooms, auditoria, and lecture halls; command and control centers; digital signage, and more. Concerts and corporate events are among the most obvious venues where audiovisual equipment is used in a staged environment. This invention would thus be readily compatible with Automatic Message Exchange (AMX) and Crestron control panels. Finally, there is the possibility of communicating texted messages using any Internet supported device.

### BRIEF DESCRIPTION OF THE DRAWING

FIG. 1A in the replacement drawings represents the logical software device comprising the internal hard drive of any electronic device that uses the speech-to-online-text software. Data 1 and Data 2 comprise the communication interface between the internal hard drive and the speech-to-online-text software.

FIG. 1B in the replacement drawings represents the logical software device comprising any word processor on the hard drive of any electronic device that uses the speech-to-online-text software. Data 3 and Data 4 comprise the communication interface between the word processor and the speech-to-online-text software.

FIG. 1C in the replacement drawings represents the logical software device comprising the external hard drive of any electronic device that uses the speech-to-online-text software. Data 5 and Data 6 comprise the communication interface between the external hard drive and the speech-to-online-text software.

FIG. 1D in the replacement drawings represents the logical software device comprising an internet/intranet supported webpage on any electronic device that uses the speech-to-online-text software. Data 7 and Data 8 comprise the communication interface between the internet/intranet supported webpage and the speech-to-online-text software.

FIG. 1E in the replacement drawings represents the logical software device comprising the speech-to-online-text. The speech-to-online-text and the internal hard drive (FIG. 1A of the replacement drawings) communicate with each other via the interface represented by Data 1 and Data 2. The speech-to-online-text and the word processor (FIG. 1B of the replacement drawings) communicate with each other via the interface represented by Data 3 and Data 4. The speech-to-online-text and the external hard drive (FIG. 1C of the replacement drawings) communicate with each other via the interface represented by Data 5 and Data 6. The speech-to-online-text and the internet/intranet supported webpage (FIG. 1C of the replacement drawings) communicate with each other via the interface represented by Data 7 and Data 8.

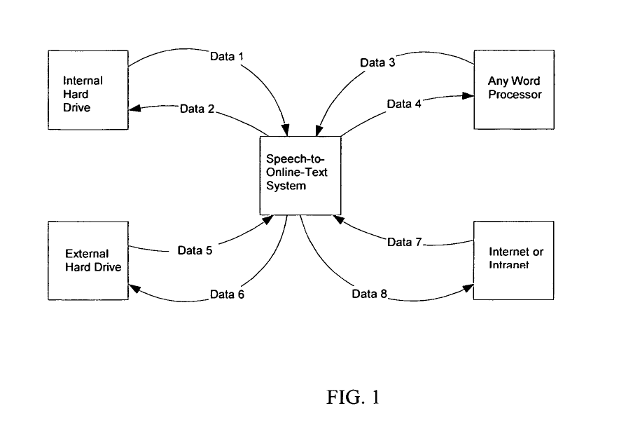

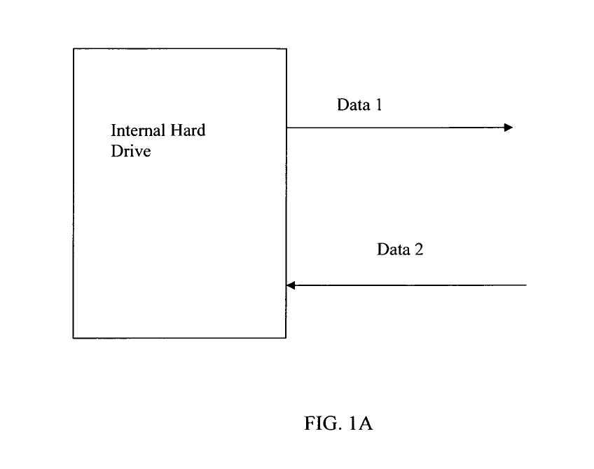

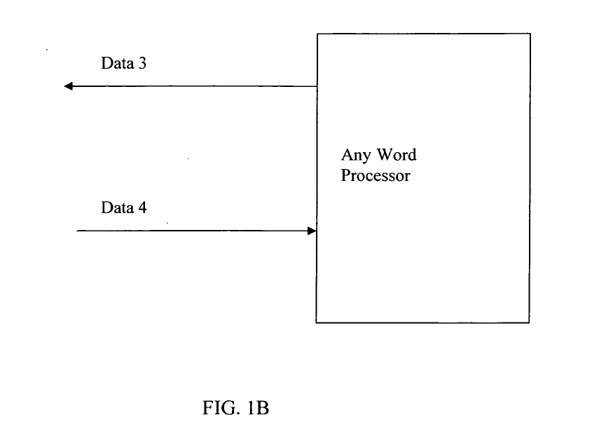

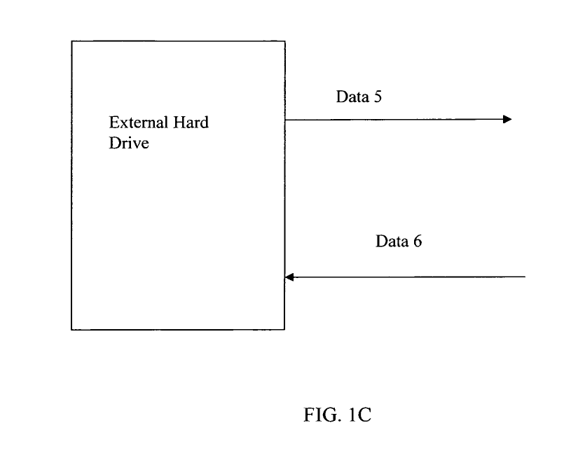

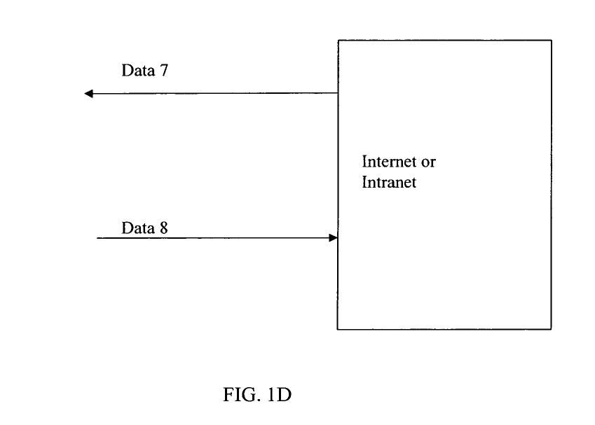

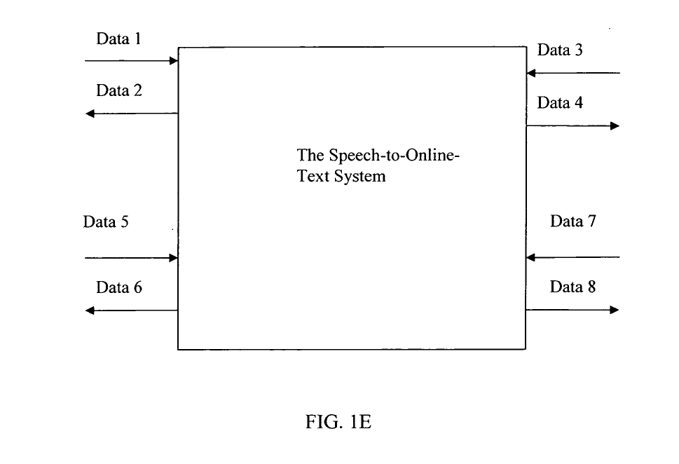

### DETAILED DESCRIPTION OF THE PREFERRED EMBODIMENTS

Data 1 and Data 2: The speech-to-online-text system must support the flow of data between itself and the logical software device comprising the internal hard drive. The speech-to-online-text software must be stored on the internal hard drive, and, upon activation of the speech-to-online-text software, must be able to communicate with a speech-to-online-text supported webpage. There will be some handshaking protocol that will ensure that the speech-to-online-text software stored on the internal hard drive is not corrupted. Furthermore, speech-to-online-text software upgrades may be downloaded to the internal hard drive as well.

Data 3 and Data 4: The speech-to-online-text system must support the flow of data between itself and any word processors on the hard drive containing the speech-to-online-text software.

Data 5 and Data 6: The speech-to-online-text system must support the flow of data between itself and the logical software device comprising the external hard drive. Depending on the external hard drive space, the speech-to-online-text software can be stored on the external hard drive and, upon activation of the speech-to-online-text software, must be able to communicate with a speech-to-online-text supported webpage. There will be some handshaking protocol that will ensure that the speech-to-online-text software stored on the external hard drive is not corrupted. Furthermore, speech-to-online-text software upgrades may be downloaded to the external hard drive as well. The external hard drive could also be represented by a thumb drive, a printer, a scanner, a digital writing pad, cellphone, PDA, or a mouse.

Data 7 and Data 8: The speech-to-online-text system must support the flow of data between itself and any internet/intranet supported webpage.

1. A logical software device representing the software that enables the speech-to-online-text technology

2. The interface between the logical software device recited in claim 1 and a word processor on any internet/intranet supported electronic device supporting the WBWS (i.e. Windows based electronic device, Apple product, Linux supported product, PDA, cellphone, or any device with a derivative operating system)

3. The interface between the logical software device recited in claim 1 and the data network that comprises the Internet

4. The interface between the logical software device recited in claim 1 and the data network that comprises an Intranet

5. The interface between the logical software device recited in claim 1 and the logical software device representing the internal hard drive of any internet/intranet supported electronic device (i.e. Windows based electronic device, any Apple product, Linux supported product, Linux, PDA, cellphone, or any device with a derivative operating system)

6. The interface between the logical software device recited in claim 1 and the logical software device representing ANY external hard drive connected to any internet/intranet supported electronic device supporting the WBWS (i.e. Windows based electronic device, any Apple product, Linux supported product, PDA, cellphone, or any device with a derivative operating system)
